(19) United States
(12) Patent Application Publication
(10) Pub. No.: US 2020/0139741 A1
(43) Pub. Date: May 7, 2020

(54) Customizable Greeting Card System and Method

(71) Applicant: Jamunarani Ramaraj, Fremont, CA (US)

(72) Inventor: Jamunarani Ramaraj, Fremont, CA (US)

(21) Appl. No.: 16/733,873

(22) Filed: Jan. 3, 2020

Related U.S. Application Data
(60) Provisional application No. 62/801,849, filed on Feb. 6, 2019.
(60) Provisional application No. 62/798,013, filed on Jan. 29, 2019.
(60) Provisional application No. 62/787,905, filed on Jan. 3, 2019.

(51) Int. Cl. B42D 15/02

(52) U.S. Cl. CPC B42D 15/022; B42D 15/042

(57) ABSTRACT

A customizable greeting card system. The customizable greeting card system includes a greeting card. The greeting card has an outer face displayed oppositely of an inner face. The inner face is designed to include a parallel circuit therein. The parallel circuit includes a power source, as well as a number of electronic devices. Each electronic device has a power receiver that receives power from the power source. The electronic devices are programmed to perform at least one desired function.

### CROSS REFERENCE TO RELATED APPLICATIONS

This application claims the benefit of U.S. Provisional Application No. 62/787,905 filed on Jan. 3, 2019, U.S. Provisional Application No. 62/798,023 filed on Jan. 29, 2019, and U.S. Provisional Application No. 62/801,849 filed on Feb. 6, 2019. The above identified patent applications are herein incorporated by reference in their entirety to provide continuity of disclosure.

### BACKGROUND OF THE INVENTION

The present, invention relates to a customizable greeting card system and a method of use therefor. More specifically, the present system includes a system that can be utilized in conjunction with a greeting card to create an interactive and customized greeting card experience.

Many people utilize greeting cards to communicate with their family or friends on holidays, birthdays or other special occasions. These greeting cards typically are printed on paper and include a decorative element on an outer surface and a literary element on the inner surface. Sometimes, cards will play recorded musical numbers, display a pre-programmed light arrangement, or will perform some other programmed response.

These devices, however, do not allow for the senders of the cards to personalize or otherwise customize the programmed response that is performed when the card is received or opened. As such, there is a defined need amongst the known art for a device that will allow enhanced customizability of a greeting card for the user.

### SUMMARY OF THE INVENTION

In view of the foregoing disadvantages inherent in the known types of greeting cards and manufacturing methods now present in the prior art, the present invention provides a customizable greeting card system wherein the same can be utilized for providing convenience for the user when creating a greeting card to an individual.

The present system comprises a greeting card. The greeting card defines an inner face opposite of an outer face. The inner face is designed to display information for the greeting card recipient and the outer face is designed to display a decorative element. The greeting card includes a parallel surface incorporated therein. The parallel circuit defines a power source. The parallel circuit further includes a plurality of electronic devices. Each electronic device is configured to perform a specific function. Additionally, each electronic device comprises a power receiver. Each power receiver is in operable connection with the power source, such that power is provided to each electronic device on the parallel circuit. A controller may also be in operable connection with the parallel circuit.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of an inner face of the customizable greeting card system.

FIG. 2 shows a perspective view of an outer face of an embodiment of the customizable greeting card system.

FIG. 3 shows a block diagram of an embodiment of the customizable greeting card system.

### DETAILED DESCRIPTION OF THE INVENTION

Reference is made herein to the attached drawings. Like reference numerals are used throughout the drawings to depict like or similar elements of the customizable greeting card system. The figures are intended for representative purposes only and should not be considered to be limiting in any respect.

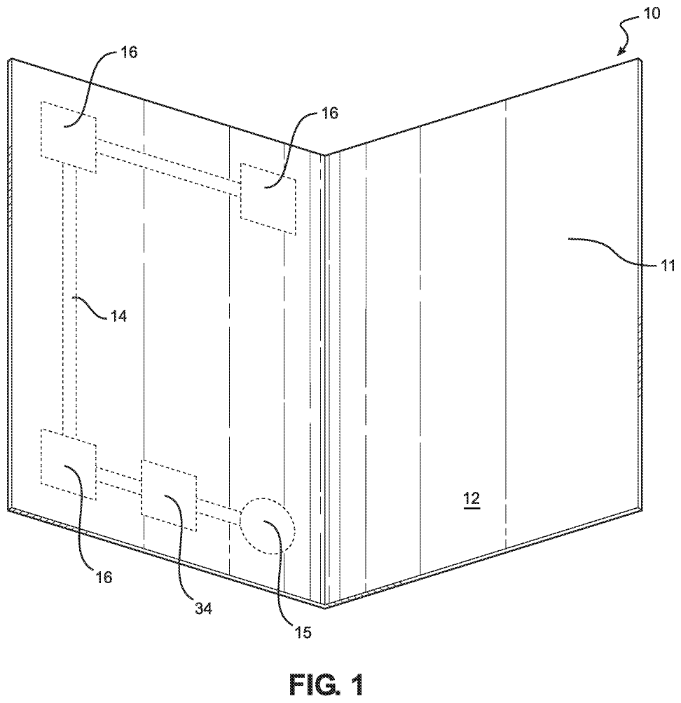

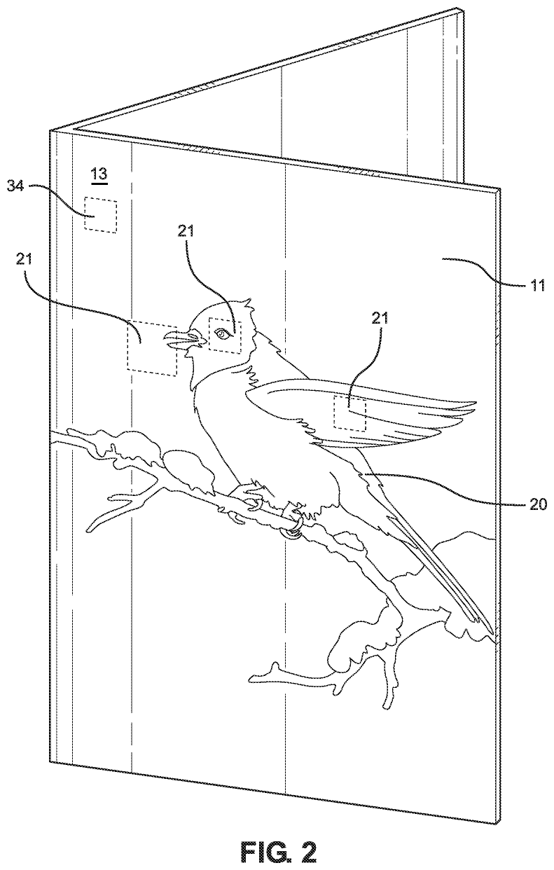

Referring now to FIG. 1, there is shown a perspective view of an embodiment of an inner face of the customizable greeting card system. The customizable greeting card system 10 comprises a greeting card 11. The greeting card 11 defines an inner face 12 displayed oppositely an outer face 13 (shown in FIG. 2).

The customizable greeting card system 10 further comprises a parallel circuit 14. In the illustrated embodiment, the parallel circuit 14 is disposed upon the inner face of the greeting card 13. The parallel circuit 14 is made of any conductive material capable of containing and transmitting an electrical current from a first location to a second location. In some embodiments, the parallel circuit 14 is made of a flexible material, such as a conductive clay material. As such, the user will be able to set up the parallel circuit 14 into any number of desired configurations. Additionally, the parallel circuit 14 is operably connected to a power source 15. The power source 15 is of any suitable configuration for powering any operably connected components to the parallel circuit 14. In some embodiments, a switch 34 may be operably disposed on the parallel circuit 14 downstream from the power source 15. As such, the switch 34 may be used to supply or to cut off power from the power source 15 to the parallel circuit 14. The switch 34 may be of any suitable structure or configuration, such as a push button switch or a flip switch.

A plurality of electronic devices 16 are in operable connection with the parallel circuit 14. As such, power can flow from the power source 15 along the parallel circuit 14 to the plurality of electronic devices 16. In some embodiments, the parallel circuit 14 defines ports configured to receive a desired electronic device of the plurality of electronic devices 16. The ports may be configured to be universal, such that any electronic device of the electronic devices 16 may be inserted therein, in the illustrated embodiment, each electronic device of the plurality of electronic devices is attached to the parallel circuit 14 in a linear manner. As such, each electronic device of the plurality of electronic devices 16 comprises a power receiver in operable connection therewith. The power receiver is configured to supply power from the power source 15 to the corresponding electronic device.

Referring now to FIG. 2, there is shown a perspective view of an outer face of an embodiment of the customizable greeting card system. In the illustrated embodiment, the outer face 13 of the greeting card 11 comprises a decorative display 20 thereon. The decorative display 20, in the specific embodiment, reflects a bird sitting on a branch, in alternative embodiments, any decorative design 20 may be utilized. No claim is made in this application to the specific decorative design 20 shown in the depicted embodiment.

In some embodiments, the customizable greeting card system 10 comprises a template. The template is configured to designate a position of at least one of the electronic devices of the plurality of electronic devices. In the illustrated embodiment, the template comprises a plurality of designations 21 that correspond to the decorative design 20 printed on the outer face 13 of the greeting card 11. The template designations 21 may correspond to the decorative design 20 in a manner in which the functionality of the specific electronic device is reflected. For example, if the decorative design 20 includes a bee, the template may include a designation 21 to place a vibrator in a corresponding position to the bee, such as to simulate buzzing of the bee. Additionally, the decorative design 20 could include an element configured to correspond to a light, such as a lantern or automobile light.

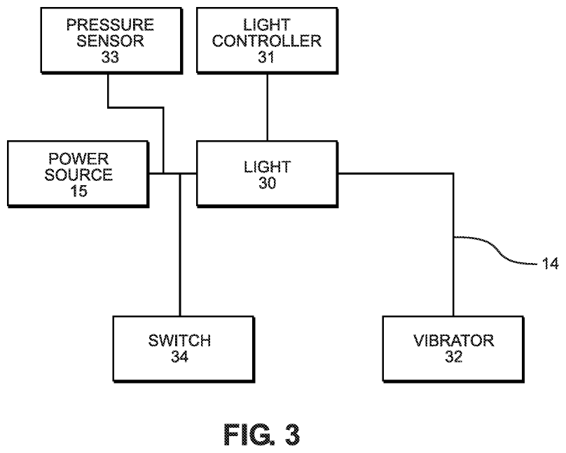

Referring now to FIG. 3, there is shown a block diagram of an embodiment of the customizable greeting card system. In the illustrated embodiment, various electronic devices of the plurality of electronic devices are demonstrated. In practice, the position and function of each electronic device varies by each embodiment. In some embodiments, the plurality of electronic devices comprises at least one light source 30. The light source 30 in configured to display a light upon actuation. The light source 30 may be of any suitable configuration, such as a light electric diode (LED).

In some further embodiments, each light source 30 is in operable connection with a light controller 31. The light controller 31 may be programmed to actuate and deactuate one or more light sources 30 in a sequential order. As such, the light sources may blink, flash or strobe as desired by the user. Furthermore, in some embodiments having multiple light sources 30, the light sources 30 may be of different colors, sizes or configurations, in yet another embodiment, the light source or light sources 30 are in operable connection with a slider switch. As such, engagement of the slider switch will manually actuate and deactuate the light source or light sources 30.

In some embodiments, the plurality of electronic devices comprises at least one vibrator 32. The vibrator 32 is configured to produce vibrations against the surface on which the vibrator 32 is placed. As such, a vibrating sensation and a vibrating sound are produced for the user and are configured to enhance the experience of receiving the customized greeting card. The vibrator 32 may be of any suitable configuration for creating vibration. For example, the vibrator 32 may be an eccentric rotating mass (ERM) actuator or a linear resonant actuator (IRA). Ideally, the vibrator 32 will be light weight and discrete in configuration, size and shape to better fit into the greeting card itself.

In other embodiments, the parallel circuit 14 may comprises a pressure sensor 33. The pressure sensor 33 may be configured to actuate or deactuate electronic devices as the greeting card is opened or closed. For example, the pressure sensor 33 may be placed upon the parallel circuit 14 such that a light source 30 is actuated when pressure is applied to the pressure sensor 33, such as pressure that could be applied by an individual in possession of the greeting card, or pressure from the greeting card being folded over upon itself in a closed configuration.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A customizable greeting card system, comprising:
a greeting card, defining an outer face and an inner face;
the greeting card including a parallel circuit disposed on the inner face thereof;
the parallel circuit comprising a power source;
the parallel circuit further comprising a plurality of electronic devices;
each electronic device of the plurality of electronic devices comprising a power receiver;
the power receiver in operable connection with the power source
a switch in operable connection with the parallel circuit.

2) The customizable greeting card system of claim 1, wherein the plurality of electronic devices comprises at least one light source.

3) The customizable greeting card system of claim 1, wherein the plurality of electronic devices comprises at least one vibrator.

4) The customizable greeting card system of claim 1, wherein the greeting card comprises a template, the template configured to designate a position of at least one of the electronic devices of the plurality of electronic devices.

5) The customizable greeting card system of claim 2, wherein the plurality of light sources comprises at least two lights, wherein each light is of a different color.

6) The customizable greeting card system of claim 2, wherein the at least one light source is in operable connection with a light controller.

7) The customizable greeting card system of claim 6, wherein the light controller is configured to actuate and deactuate the at least one light source in a sequential order.

8) The customizable greeting card system of claim 2, wherein the at least one light source is in operable connection with a slider switch.

9) The customizable greeting card system of claim 1, wherein the parallel circuit further comprises a conductive clay material.

10) The customizable greeting card system of claim 1, wherein the parallel circuit, further comprises a pressure sensor.

11) A method of creating a greeting card, comprising the steps of:
creating a template on an inner surface of a greeting card, the template having a power source indicia, a power receiver indicia and a switch indicia;
affixing a power source to an inner surface of a greeting card at the power source indicia;
affixing a plurality of power receivers to the inner surface of the greeting card at each power receiver indicia;
affixing a switch to the inner surface of the greeting card at the switch indicia;
creating a parallel circuit from the power source to each of the plurality of power receivers and the switch;
affixing an electronic device to each power receiver of the plurality of power receivers.

12) The method of creating a greeting card of claim 11, further comprising: placing at least one light source in operable connection with at least one power receiver of the plurality of power receivers.

13) The method of creating a greeting card of claim 11, further comprising: placing at least one vibrator in operable connection with at least one power receiver of the plurality of power receivers.

14) The method of creating a greeting card of claim 11, further comprising: placing a pressure sensor in operable connection with the parallel circuit.
